(19) United States
(12) Patent Application Publication
(10) Pub. No.: US 2025/0230376 A1
(43) Pub. Date: Jul. 17, 2025

(54) HEAT SOURCE MACHINE, OPERATION METHOD OF THE SAME, AND REFRIGERATING MACHINE OIL FOR HEAT SOURCE MACHINE

(71) Applicants: MITSUBISHI HEAVY INDUSTRIES THERMAL SYSTEMS, LTD., Tokyo (JP); ENEOS CORPORATION, Tokyo (JP)

(72) Inventors: Hiroyuki YUKI, Tokyo (JP); Norihisa HORAGUCHI, Tokyo (JP); Kazuki WAJIMA, Tokyo (JP); Ryosuke SUEMITSU, Tokyo (JP); Yohei SHONO, Tokyo (JP)

(73) Assignees: MITSUBISHI HEAVY INDUSTRIES THERMAL SYSTEMS, LTD., Tokyo (JP); ENEOS CORPORATION, Tokyo (JP)

(21) Appl. No.: 18/727,882

(22) PCT Filed: Dec. 21, 2022
(86) PCT No.: PCT/JP2022/047099

§ 371 Date: Jul. 10, 2024

(30) Foreign Application Priority Data
Jan. 14, 2022 (JP) 2022-004393

(51) Int. Cl. C10M 169/04; C09K 5/04; C10M 105/38; C10M 129/18; C10N 20/02; C10N 40/30; F25B 13/00

(52) U.S. Cl. CPC C10M 169/04; C09K 5/045; C10M 105/38; C10M 129/18; F25B 13/00; C09K 2205/126; C09K 2205/24; C10M 2207/042; C10M 2207/2835; C10N 2020/02; C10N 2040/30

(57) ABSTRACT

Provided are a heat source machine and an operation method of the same that employ predetermined solutions by using a predetermined refrigerating machine oil that can suppress deterioration of the refrigerating machine oil and viscosity reduction when a refrigerant is dissolved in the refrigerating machine oil. In the heat source machine (10) of the present disclosure, a compressor (11), a condenser (12), an expansion valve (13), and an evaporator (14) are connected to each other via main pipes (L₁ to L₈) to form a refrigerant circulation circuit configured to circulate a refrigerant, and the refrigerant circulation circuit is filled with HFO-1336mzz (Z) as a refrigerant. The heat source machine includes a refrigerating machine oil supply unit (15) configured to supply a refrigerating machine oil to the compressor (11), the refrigerating machine oil supply unit (15) includes a storage unit (15a) storing the refrigerating machine oil, the refrigerating machine oil includes an ester-based base oil having a dynamic viscosity of 100 mm²/s to 180 mm²/s at 40° C. and an epoxy-based acid scavenger at a mass of 0.1% by mass to 6% by mass with respect to a total mass of the refrigerating machine oil, and the machine design temperature is 130° C. or higher and 225° C. or lower.

### TECHNICAL FIELD

The present disclosure relates to a heat source machine, an operation method of the same, and a refrigerating machine oil for a heat source machine.

### BACKGROUND ART

For heat source machines such as a heat pump device and a refrigerating machine, hydrofluorocarbon-based refrigerants (HFC refrigerants) are conventionally used. Such HFC refrigerants may be, for example, 1,1,1,2-tetrafluoroethane (HFC-134a). The ozone depletion potential of HFC refrigerants is zero, and the thermochemical stability thereof is high.

On the other hand, HFC refrigerants have extremely high global warming potential (GWP) ranging from hundreds to thousands. Thus, use of HFC refrigerants is undesirable in terms of global environment protection.

Accordingly, in recent years, in terms of environmental protection, heat source machines using hydrofluoroolefin-based refrigerants (HFO refrigerants) having low GWP have been developed (see Patent Literature 1, Patent Literature 2). Such HFO refrigerants may be, for example, a tetrafluoropropene-based refrigerant such as 2,3,3,3-tetrafluoropropene (HFO-1234yf).

In recent years, heat source machines have been attracting attention as an alternative to boiler products that generate hot water and steam by burning fossil fuels or the like. Since electricity is used to produce hot water and steam in the heat source machine, emission of the greenhouse gas, CO₂, can be reduced.

### CITATION LIST

### Patent Literature

### [PTL 1]

Japanese Patent No. 6065429

### [PTL 2]

Japanese Patent Application Laid-Open No. 2013-129732

### SUMMARY OF INVENTION

### Technical Problem

In a heat source machine such as a heat pump device and a refrigerating machine, a refrigerating machine oil is supplied to a compressor. A heat source machine that is filled with HFC-134a as a refrigerant and provides tapping (output) at less than 100° C. is formed of a two-stage compression and one-stage expansion economizer cycle, and a refrigerating machine oil with a viscosity grade of ISO VG100 or less is used. A part of the refrigerating machine oil leaks into a refrigerant circulation circuit during operation of the heat source machine and circulates in the refrigerant circulation circuit together with the refrigerant. Herein, the refrigerating machine oil is compatible with the refrigerant and helps the compressor lubrication.

The refrigerating machine oil is decomposed by heat and oxidization and thereby deteriorated. In particular, deterioration of the refrigerating machine oil may be accelerated in a compressor using the HFO refrigerant. Such deterioration of a refrigerating machine oil may be a factor in occurrence of a compressor lubrication failure. An acid component (hydrofluoric acid, carboxylic acid, or the like) generated by decomposition of a refrigerant or a refrigerating machine oil corrodes metals of a condenser, an evaporator, a pipe, or the like. Corrosion of the metal may be a factor in leakage of the refrigerant into the atmosphere.

In heat source machines that generate tapping (output) or steam exceeding 100° C., there is a challenge that, if the circulating refrigerant or refrigerating machine oil is thermally and oxidatively deteriorated, commercialization of the heat source machine (establishment as a system) is no longer possible due to the following events.

When decomposition of a refrigerating machine oil (an additive) proceeds due to thermal and oxidative deterioration, this may be a factor in occurrence of a compressor lubrication failure.

Acid components (hydrofluoric acid, carboxylic acid, or the like) generated by deterioration may cause corrosion of metals of a heat exchanger, a pipe, and the like and leakage of the refrigerant or the like into the atmosphere.

Even if a refrigerating machine oil that can be used stably at a design machine requirement temperature (at a hot water temperature of 160° C. or lower during operation) is found, the oil viscosity decreases as the refrigerating machine oil is dissolved in the refrigerant. When the decrease in the oil viscosity is significant, formation of an oil film on sliding surfaces (lubricated surfaces) is insufficient, which may be a factor that causes abnormal wear.

The present disclosure has been made in view of such circumstances and intends to provide a heat source machine, an operation method of the same, and a refrigerating machine oil for a heat source machine that employ predetermined solutions by using a predetermined refrigerating machine oil that can suppress deterioration of the refrigerating machine oil and suppress a viscosity reduction when a refrigerant is dissolved in the refrigerating machine oil.

### Solution to Problem

To solve the above problem, the heat source machine, the operation method of the same, and the refrigerating machine oil for the heat source machine of the present disclosure employ the following solution.

The present disclosure provides a heat source machine in which a compressor, a condenser, an expansion valve, and an evaporator are connected to each other via a main pipe to form a refrigerant circulation circuit configured to circulate a refrigerant, and the refrigerant circulation circuit is filled with HFO-1336mzz (Z) (1,1,1,4,4,4-hexafluoro-2-butene) as a refrigerant. The heat source machine includes: a refrigerating machine oil supply unit configured to supply a refrigerating machine oil to the compressor, the refrigerating machine oil supply unit includes a storage unit storing the refrigerating machine oil, the refrigerating machine oil includes an ester-based base oil having a dynamic viscosity that is greater than or equal to 100 mm²/s and less than or equal to 180 mm²/s at 40° C. and an epoxy-based acid scavenger at a mass that is greater than or equal to 0.1% by mass and less than or equal to 6% by mass with respect to a total mass of the refrigerating machine oil, and the machine design temperature is greater than or equal to 130° C. and less than or equal to 225° C.

The present disclosure provides an operation method of a heat source machine in which a compressor, a condenser, an expansion valve, and an evaporator are connected to each other via a main pipe to form a refrigerant circulation circuit configured to circulate a refrigerant, and the refrigerant circulation circuit is filled with HFO-1336mzz (Z) as a refrigerant, the machine design temperature is greater than or equal to 130° C. and less than or equal to 225° C. The operation method includes: supplying the refrigerating machine oil to the compressor, the refrigerating machine oil including an ester-based base oil having a dynamic viscosity that is greater than or equal to 100 mm²/s and less than or equal to 180 mm²/s at 40° C. and an epoxy-based acid scavenger at a mass that is greater than or equal to 0.1% by mass and less than or equal to 6% by mass with respect to a total mass of the refrigerating machine oil.

The present disclosure provides a refrigerating machine oil for a heat source machine in which a compressor, a condenser, an expansion valve, and an evaporator are connected to each other via a main pipe to form a refrigerant circulation circuit configured to circulate a refrigerant, and the refrigerant circulation circuit is filled with HFO-1336mzz (Z) as a refrigerant. The heat source machine includes a refrigerating machine oil supply unit configured to supply a refrigerating machine oil to the compressor, and the refrigerating machine oil supply unit includes a storage unit storing the refrigerating machine oil, and the machine design temperature is greater than or equal to 130° C. and less than or equal to 225° C., the refrigerating machine oil for a heat source machine includes: an ester-based base oil having a dynamic viscosity that is greater than or equal to 100 mm²/s and less than or equal to 180 mm²/s at 40° C. and an epoxy-based acid scavenger at a mass that is greater than or equal to 0.1% by mass and less than or equal to 6% by mass with respect to a total mass of the refrigerating machine oil.

The ester-based base oil has compatibility with HFO-1336mzz (Z). By adding an epoxy-based acid scavenger at a mass that is greater than or equal to 0.1% by mass and less than or equal to 6% by mass, preferably greater than or equal to 1% by mass and less than or equal to 6% by mass, and more preferably greater than or equal to 3% by mass and less than or equal to 6% by mass with respect to the total mass of the refrigerating machine oil, a mixed liquid of the refrigerant and the refrigerating machine oil is thermochemically stabilized. The mixed liquid can suppress thermal and oxidative deterioration even in the operation temperature range of 225° C. or less in coexistence of the refrigerant. Even when the refrigerant is dissolved in the refrigerating machine oil, the refrigerating machine oil described above can prevent a viscosity reduction and satisfy a design requirement value.

### Advantageous Effects of Invention

According to the present disclosure, even when the refrigerant is dissolved in the refrigerating machine oil, it is possible to suppress the deterioration of the refrigerating machine oil due to heat while ensuring a required viscosity. This improves the (lubrication) lifetime of the compressor and establishes a high-temperature heat pump system (a machine configuration), so as to provide a stable machine.

### BRIEF DESCRIPTION OF DRAWINGS

FIG. 1 is a schematic configuration diagram illustrating an example of a heat source machine.

FIG. 2 is a graph illustrating test results of thermal decomposability.

### DESCRIPTION OF EMBODIMENTS

An embodiment of a heat source machine, an operation method of the same, and a refrigerating machine oil for a heat source machine according to the present disclosure will be described below with reference to the drawings.

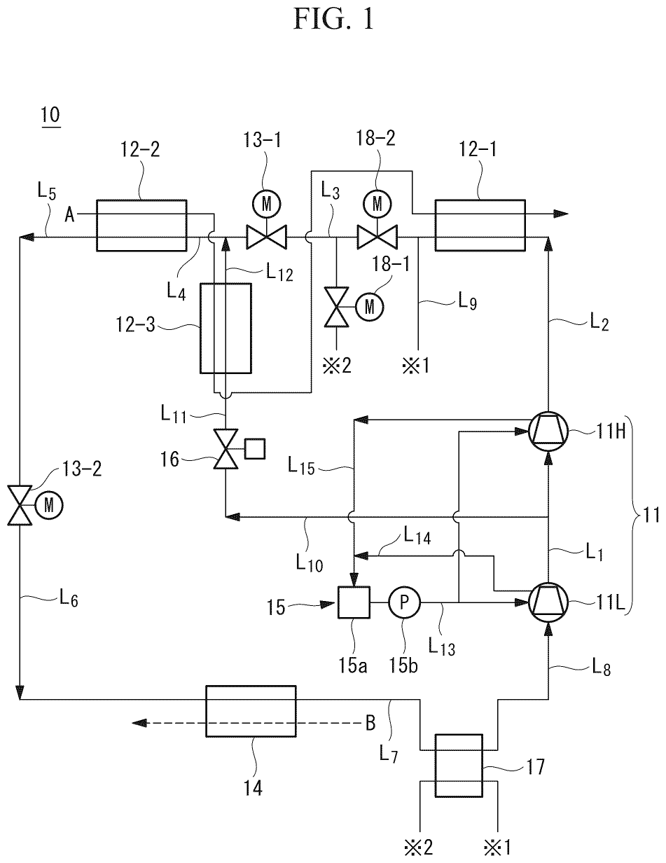

FIG. 1 is a schematic configuration diagram illustrating an example of a heat source machine according to the present embodiment.

A heat source machine 10 includes a compressor 11 configured to compress a refrigerant, a condenser 12-1, a condenser 12-2, and a condenser 12-3 configured to condense the refrigerant that has been compressed by the compressor 11, a first expansion valve 13-1 configured to expand a liquid refrigerant from the condenser 12-1, a second expansion valve 13-2 configured to expand a liquid refrigerant from the condenser 12-2, and an evaporator 14 configured to evaporate the refrigerant that has been expanded by the second expansion valve 13-2.

The heat source machine 10 includes a refrigerating machine oil supply unit 15.

The heat source machine 10 includes an intercooler (an interheater) 17 configured to perform heat exchange between a refrigerant gas from the evaporator 14 outlet and a refrigerant liquid from the condenser 12-1 outlet. The heat source machine 10 includes an intercooler flow regulating valve 18-1 configured to adjust a liquid refrigerant flow rate to the intercooler 17 and an intercooler bypass valve 18-2. Note that the intercooler 17, the intercooler flow regulating valve 18-1, and the intercooler bypass valve 18-2 may be omitted.

The compressor 11, the condenser 12-1, the condenser 12-2, the first expansion valve 13-1, the second expansion valve 13-2, and the evaporator 14 are connected to each other by main pipes (pipes, from L₁ to L₈) to form a closed system (a heat pump cycle/a refrigerant circulation circuit) configured to circulate the refrigerant. The heat pump cycle is filled with HFO-1336mzz (Z) as the refrigerant. Each component member of the heat source machine 10 is designed to be able to withstand a pressure from the refrigerant. The machine design temperature of the heat source machine 10 is designed to be greater than or equal to 130° C. and less than or equal to 225° C.

The compressor 11 is a centrifugal compressor or the like with which a high pressure ratio can be obtained. In FIG. 1, the compressor 11 is formed of a low-pressure side compressor 11L and a high-pressure side compressor 11H. The discharge side of the low-pressure side compressor 11L and the intake side of the high-pressure side compressor 11H are connected to each other via the pipe L₁. One end of the pipe L₂ is connected to the discharge side of the high-pressure side compressor 11H. The compressor 11 can raise a refrigerant temperature to about 225° C. during operation.

The other end of the pipe L₂ is connected to the intake side of the condenser 12-1. One end of the pipe L₃ is connected to the discharge side of the condenser 12-1. The condenser 12-1 is a heat exchanger configured to perform heat exchange between a high-pressure refrigerant and hot water. As the condenser 12-1, a plate type heat exchanger and a plate fin type heat exchanger are preferably used; however, a shell and tube type heat exchanger may be used. In the condenser 12-1, a high-temperature high-pressure refrigerant is deprived of latent heat of condensation by the heated hot water and becomes a medium-temperature high-pressure liquid refrigerant. The hot water is heated by latent heat of condensation and becomes high-pressure water exceeding 100° C.

The other end of the pipe L₃ is connected to the intake side of the first expansion valve 13-1. One end of the pipe L₄ is connected to the discharge side of the first expansion valve 13-1.

The other end of the pipe L₄ is connected to the intake side of the condenser 12-2. One end of the pipe L₅ is connected to the discharge side of the condenser 12-2. The condenser 12-2 is a heat exchanger configured to perform heat exchange between a medium-temperature medium-pressure refrigerant and hot water A.

The other end of the pipe L₅ is connected to the intake side of the second expansion valve 13-2. One end of the pipe L₆ is connected to the discharge side of the second expansion valve 13-2.

The first expansion valve 13-1 and the second expansion valve 13-2 are electronic expansion valves, motorized ball valves, or the like. The opening degrees of the first expansion valve 13-1 and the second expansion valve 13-2 may be controlled by a control unit (not illustrated). The liquid refrigerant discharged from the condenser 12-2 is expanded under reduced pressure in the second expansion valve 13-2.

The other end of the pipe L₆ is connected to the intake side of the evaporator 14. One end of the pipe L₇ is connected to the discharge side of the evaporator 14. The evaporator 14 is a heat exchanger configured to perform heat exchange between the refrigerant and heat source water B. A plate type heat exchanger is preferably used as the evaporator 14. The low-temperature low-pressure liquid refrigerant discharged from the second expansion valve 13-2 is evaporated by the evaporator 14 and becomes a low-temperature low-pressure gas. Herein, the heat source water B is cooled by the latent heat of vaporization.

The other end of the pipe L₇ is connected to the intake side of the intercooler 17. One end of the pipe L₈ is connected to the discharge side of the intercooler 17. The intercooler 17 is a heat exchanger configured to perform heat exchange between the low-temperature low-pressure gas refrigerant evaporated in the evaporator 14 and a high-temperature high-pressure liquid refrigerant discharged from the condenser 12-1. The other end of the pipe L₈ is connected to the intake side of the compressor 11 (low-pressure side compressor 11L).

A part of the pipe L₃ serves as an intercooler bypass path. An intercooler bypass valve 18-2 is installed in the intercooler bypass path. One end of the pipe L₉ is connected to the inlet side of the bypass path. The other end of the pipe L₉ is connected to the outlet side of the bypass path via the intercooler 17. The intercooler flow regulating valve 18-1 is installed on the other end side of the pipe L₉.

The control unit (not illustrated) of the heat source machine 10 is provided on a control board in a control panel of the heat source machine 10 and includes a CPU and a memory. The control unit calculates each control amount by digital calculation for each control cycle based on hot water inlet/outlet temperatures, a refrigerant pressure, heat source water inlet/outlet temperatures, or the like.

In FIG. 1, one end of the pipe L₁₀ for medium bleeding is connected to the medium discharge pipe L₁. The other end of the pipe L₁₀ is connected to the inlet side of a check valve 16 for the medium bleeding. The outlet side of the check valve 16 for medium bleeding is connected to the inflow side of the condenser 12-3 via the pipe L₁₁. The outflow side of the condenser 12-3 is connected to one end of the pipe L₁₂. The other end of the pipe L₁₂ is connected to the pipe L₄.

The refrigerating machine oil supply unit 15 is connected to the compressor 11. In FIG. 1, the refrigerating machine oil supply unit 15 includes a storage unit 15a such as a tank, a feeding unit 15b such as a pump, a supply line L₁₃, a drain oil line L₁₄, and a drain oil line L₁₅.

The storage unit 15a is connected to the oil inlets of the low-pressure side compressor 11L and the high-pressure side compressor 11H via the feeding unit 15b and the supply line L₁₃. The refrigerating machine oil is stored in the storage unit 15a.

The drain oil line L₁₄ connects the oil outlet of the low-pressure side compressor 11L and the storage unit 15a to each other. The drain oil line Lis connects the oil outlet of the high-pressure side compressor 11H and the storage unit 15a to each other.

The refrigerating machine oil supply unit 15 is not limited to the above and can be configured to feed a refrigerating machine oil to the compressor 11, for example, may be built in the bottom of the compressor. The supply line L₁₃ is branched into two systems of the low-pressure side compressor 11L and the high-pressure side compressor 11H. However, the configuration is not limited to the configuration in which a single oil pump (the feeding unit 15b) is provided and the supply line is branched in the middle, as illustrated in FIG. 1, and may be a configuration in which two oil pumps are provided to supply a refrigerating machine oil via two systems, independently.

The refrigerating machine oil contains a base oil and an acid scavenger. The refrigerating machine oil may contain an additive such as an antioxidant. However, it is desirable not to add a phosphorus-based lubricant. The phosphoric acid ester-based compound may be a factor in hydrolyzing an ester that is a dehydration-condensation reaction product between an acid and an alcohol or in generating an acid when heated.

The base oil is an ester-based oil whose dynamic viscosity at 40° C. (compliant with JIS K2283) is greater than or equal to 100 mm²/s and less than or equal to 180 mm²/s. The dynamic viscosity is preferably greater than or equal to 120 mm²/s and less than or equal to 170 mm²/s, more preferably greater than or equal to 130 mm²/s and less than or equal to 160 mm²/s. The ester-based oil has compatibility with the refrigerant HFO-1336mzz (Z). When the dynamic viscosity of the base oil is high, the starting torque of the compressor 11 increases, and a mechanical loss occurs. It is thus preferable that the viscosity of the base oil be as low as possible. On the other hand, a higher dynamic viscosity of the base oil is preferable for ensuring lubricity.

For example, the base oil is a polyol ester obtained by dehydration condensation between a polyhydric alcohol and a C5 to C18 fatty acid. The dynamic viscosity of the base oil can be adjusted by the backbone of the polyhydric alcohol, the number of carbon atoms in the fatty acid, and the blend ratio thereof. The polyhydric alcohol may be neopentyl glycol (—OH: divalent), trimethylolpropane (—OH: trivalent), pentaerythritol (—OH: tetravalent), dipentaerythritol (DPE, —OH: hexavalent), or the like.

The acid scavenger may be added at 0.1% by mass or greater and 6% by mass or less, preferably 1% by mass or greater, more preferably 2% by mass or greater, more preferably 3% by mass or greater, and may be added at 5% by mass or less or 4% by mass or less with respect to the total mass of the refrigerating machine oil.

The acid scavenger is an epoxy-based compound that captures an organic acid and an inorganic acid. The acid scavenger is, for example, butyl glycidyl ether, butyric acid glycidyl ester, hexyl glycidyl ether, hexanoic acid glycidyl ester, 2-ethylhexyl glycidyl ether, 2-ethyl hexanoic acid glycidyl ester, neopentyl glycidyl ether, pivalate acid glycidyl ester, decyl glycidyl ether, decanoic acid glycidyl ester, stearyl glycidyl ether, stearic acid glycidyl ester, oleyl glycidyl ether, oleic acid glycidyl ester, phenyl glycidyl ether, benzoic acid glycidyl ester, toluyl glycidyl ether, xylenyl glycidyl ether, tertiary butyl phenyl glycidyl ether, phthalic acid glycidyl ester, or oxacyclohexyl methyloxacyclohexy Icarboxylic acid ester.

The antioxidant is, for example, a phenol-based compound that captures chain propagators (ROO·, R·) in an oxidative deterioration reaction and stops a chain reaction. The antioxidant is added at 0.2% by mass or greater and 1.5% by mass or less, preferably 0.2% by mass or greater and 1.0% by mass or less with respect to the total mass of the refrigerating machine oil.

The antioxidant is, for example, 2,6-ditertiary butyl-p-cresol, 4,4′-methylenebis(2,6-ditertiary butyl-p-cresol), 2,2′-methylenebis(4-methyl-6-tertiary butylphenol), 3,5-ditertiary butyl-4-hydroxyphenyl propionic acid-2-ethylhexyl ester, 3-tertiary butyl-4-hydroxy-5-methylphenyl propionic acid-2-ethylhexyl ester, 3,5-ditertiary butyl-4-hydroxyphenyl propionic acid tridecyl ester, 3-tertiary butyl-4-hydroxy-5-methylphenyl propionic acid tridecyl ester, 3,5-ditertiary butyl-4-hydroxyphenyl propionic acid stearyl ester, 3-tertiary butyl-4-hydroxy-5-methylphenyl propionic acid stearyl ester, bis(3,5-ditertiary butyl-4-hydroxyphenyl propionic acid)-triglycol ester, bis(3-tertiary butyl-4-hydroxy-5-methylphenyl propionic acid)-triglycol ester, or 2,5-tertiary amylhydroquinone.

Next, the operation method of the heat source machine 10 of FIG. 1 will be described.

The refrigerant circulation circuit of the heat source machine 10 is filled with HFO-1336mzz (Z) as a refrigerant from a supply port (not illustrated) and circulates the refrigerant.

The refrigerating machine oil containing the ester-based base oil, an epoxy-based acid scavenger, and a phenol-based antioxidant is stored in the storage unit 15a of the refrigerating machine oil supply unit 15. The pump 15b is activated, and the refrigerating machine oil is then fed to the compressor 11 (the low-pressure side compressor 11L and the high-pressure side compressor 11H). The amounts of the acid scavenger and antioxidant contained in the refrigerating machine oil are as described above.

The refrigerating machine oil is compatible with the refrigerant (HFO-1336mzz (Z)). Thermal and oxidative deterioration of the refrigerating machine oil can be suppressed in the operation temperature range of 225° C. or less, and good condition can be maintained for a longer period of time even in the coexistence of a refrigerant, compared to the case where no acid scavenger is added. The term “good condition” is a condition satisfying that the acid value of the refrigerating machine oil is 0.5 mgKOH/g or less and the safety factor (margin) of the refrigerant dissolution viscosity with respect to the design requirements is 1 or greater. When the acid value of the refrigerating machine oil exceeds 0.5 mgKOH/g or when the safety factor (margin) of the dissolution viscosity with respect to the design requirements falls below 1, the refrigerating machine oil is replaced. The acid value can be measured by an indicator titration method, a potentiometric titration method or the like specified by JIS K 2501, or the like. For example, as shown in Table 2, the design requirement value for a refrigerant dissolution viscosity described here means the value of the refrigerant dissolution viscosity at a planned value of the temperature of a refrigerating machine oil in contact with a bearing (130° C. or 150° C.) and a planned value of a bearing part pressure (0.31 MPa, 0.53 MPa or 0.85 MPa).

In the refrigerant circulation circuit, a low-pressure gas refrigerant ejected from the evaporator 14 is compressed in the low-pressure side compressor 11L and becomes a medium-pressure gas refrigerant. The compressed medium-pressure gas refrigerant is further compressed in the high-pressure side compressor 11H and becomes a high-pressure gas refrigerant, which is then ejected to the pipe L₂.

The ejected high-pressure gas refrigerant is sequentially guided to the condenser 12-1, the intercooler (interheater) 17, and the condenser 12-2 through the pipe L₂. In the condenser 12-1, the high-pressure gas refrigerant is subjected to heat exchange with the hot water A and cooled to be a high-pressure liquid refrigerant.

The high-pressure liquid refrigerant is guided to the first expansion valve 13-1 through the pipe L₃. The high-pressure liquid refrigerant guided to the first expansion valve 13-1 is expanded under reduced pressure and becomes a medium-pressure liquid refrigerant. The medium-pressure liquid refrigerant is guided to the condenser 12-2 through the pipe L₄. In the condenser 12-2, the medium-pressure liquid refrigerant is cooled by heat exchange with the hot water A. The medium-pressure liquid refrigerant is guided to the second expansion valve 13-2 through the pipe L₅.

The medium-pressure liquid refrigerant guided to the second expansion valve 13-2 is expanded under reduced pressure and becomes a low-pressure liquid refrigerant with adjustment of the flow rate thereof in accordance with the thermal load capacity. The low-pressure liquid refrigerant is guided to the evaporator 14 through the pipe L₆.

The low-pressure liquid refrigerant guided to the evaporator 14 is subjected to heat exchange with the heat source water B and evaporated to be a low-pressure gas refrigerant. The low-pressure gas refrigerant evaporated in the evaporator 14 passes through the pipe L₇ and the interheater (intercooler) 17 to be a low-pressure overheated gas. The low-pressure overheated gas refrigerant flows into the low-pressure side compressor 11L through the pipe L₈ and then recompressed.

A part of the medium-pressure gas refrigerant discharged from the low-pressure side compressor 11L becomes a medium-pressure liquid refrigerant in the condenser 12-3 after passing through the pipe L₁₀, the check valve 16, and the pipe L₁₁. The medium-pressure liquid refrigerant is guided to the condenser 12-2 through the pipe L₁₂.

Next, the reason for selection and the basis for setting the composition of the refrigerating machine oil will be described.

### <Test 1: Viscosity Resistance and Compatibility>

Test oils 1 to 4 were evaluated for the load (oil viscosity resistance) at compressor startup and the compatibility with the refrigerant.

Refrigerant: HFO-1336mzz (Z) (1,1,1,4,4,4-hexafluoro-2-butene, made by Chemours Company)

Test oil 1: Paraffin mineral oil-based refrigerating machine oil (dynamic viscosity at 40° C.: 100.4 mm²/s)

Test oil 2: Polyol ester oil (refrigerating machine oil containing ester synthesized from tetravalent and hexavalent polyhydric alcohols and fatty acids (dynamic viscosity at 40° C.: 89.8 mm²/s))

Test oil 3: Polyol ester oil (refrigerating machine oil containing esters synthesized from tetravalent and hexavalent polyhydric alcohols and fatty acids (dynamic viscosity at 40° C.: 151.0 mm²/s))

Test oil 4: Polyol ester oil (refrigerating machine oil containing esters synthesized from hexavalent polyhydric alcohols and fatty acids (dynamic viscosity at 40° C.: 208.2 mm²/s))

The viscosity resistance of each test oil was measured by a dynamic viscometer (compliant with JIS K 2283).

After 2 g of each test oil and 8 g of the refrigerant were weighed and put into a test tube, it was observed whether the refrigerant and the refrigerating machine oil were dissolved with each other at temperatures from +30° C. to −60° C. Note that, in Table 1, the term “compatible” means that the refrigerant and the refrigerating machine oil were dissolved with each other in the above temperature range, and the term “incompatible” means that the refrigerant and the refrigerating machine oil were separated into two layers in a part of the above temperature range (compliant with JIS K2211:2009 Annex D “Test method of compatibility with refrigerant”).

The evaluation results of the dynamic viscosity and the compatibility for each test oil are shown in Table 1.

TABLE 1

| | Test oil No. | | | |
|---|---|---|---|---|
| | 1 | 2 | 3 | 4 |
| | Mineral oil | Ester oil | | |
| Dynamic viscosity | 100.4 | 89.8 | 151.0 | 208.2 |
| (mm²/s), 40° C. | | | | |
| Dynamic viscosity | 11.18 | 10.12 | 14.51 | 18 |
| (mm²/s), 100° C. | | | | |
| Load at compressor | Within | Within | Within | Unallowable*² |
| startup (oil viscosity | allowable | allowable | allowable | |
| resistance) | range*¹ | range | range | |
| Compatibility | Incompatible | Compatible | Compatible | Compatible |
| (+30° C.~−60° C.) | | | | |

*^{1, 2}See JIS-K-2211. In the operation temperature range, the test oil is required to melt with the refrigerant to have a uniform single-layer liquid. The temperature before separation into two layers (white turbidity) is reached when the refrigerant and the refrigerating machine oil are mixed and cooled

It was confirmed that Test oils 1 to 3 have a viscosity resistance suitable for use in the compressor. It was confirmed that the ester oils of Test oils 2 and 3 are compatible with the HFO-1336mzz (Z).

### <Test 2: Refrigerant Dissolution Amount and Refrigerant Dissolution Viscosity>

After 100 g of the refrigerating machine oil (Test oil 2 or 3) was put into a 200 ml pressure-resistant container containing a vibratory viscometer and the container was vacuum de-aerated, the refrigerant was added to adjust a working fluid composition to the predetermined temperature and pressure shown in Table 2, and the refrigerant dissolution viscosity was measured. The same refrigerant as in Test 1 was used.

The results are shown in Table 2. The safety factor (margin) of the dynamic viscosity with respect to the design requirement is represented as the criterion.

TABLE 2

| | | Safety factor (margin) of dynamic viscosity | |
|---|---|---|---|
| | | with respect to design requirements | |
| Test oil No. | | 2 | 3 |
| 130° C.*² | (0.31 MPa)*³ | Less than or equal to | 2.55 |
| | | 1.8*¹ | |
| | (0.53 MPa)*³ | — | 1.75 |
| 150° C.*² | (0.53 MPa)*³ | — | 1.49 |
| | (0.85 MPa)*³ | Less than 1.0 | 1.01 |

*¹An estimated value from the viscosity of Test oil 2 and the refrigerant dissolution viscosity of Test oil 3
*²Planned values of temperatures of the refrigerating machine oil in contact with a bearing
*³Planned values of the bearing part pressure

For the refrigerant dissolution viscosity of Test oil 2, the safety factor (margin) of dynamic viscosity of Test oil 2 with respect to the design requirement was estimated to exceed 1 at 130° C. but fallen below 1 at 150° C. On the other hand, the safety factor (margin) of the dynamic viscosity of Test oil 3 with respect to the design requirement was greater than 1 at both temperatures at 130° C. and 150° C. resulting in meeting the design requirement value. According to the above results, Test oil 3 can be applied to a compressor in which the oil temperature (temperature of the refrigerating machine oil in contact with the bearing part) is 150° C. during operation of a heat source machine having a design temperature of 200° C.

### <Test 3: Thermochemical Stability>

The thermochemical stability of the refrigerating machine oil containing Test oil 3 as the base oil was evaluated in compliant with JIS K2211:2009 Annex C, “Autoclave Test”. The same refrigerant as in Test 1 was used.

Antioxidant (0.2% by mass or less) and an acid scavenger (3.0% by mass) were added to Test oil 3, which was used as the refrigerating machine oil (initial acid value: 0.01 mgKOH/g). The above addition amounts of antioxidants and acid scavenger are the values when the total mass of the refrigerating machine oil is defined as 100% by mass. A phenol-based antioxidant (2,6-di-tert·butyl-p-cresol) was used as the antioxidant. An epoxy-based acid scavenger (decanoic acid glycidyl ester) was used as the acid scavenger.

After 30 g of the refrigerating machine oil adjusted to a moisture content of 1000 ppm was weighed and put into an autoclave, and a catalyst (iron, copper, and aluminum wires), 30 g of the refrigerant, and 100 ppm of air were sealed in the autoclave, the autoclave was heated to a predetermined temperature, and the acid value of the refrigerating machine oil was measured after 168 hours (compliant with JIS K 2501).

The test results are shown in Table 3.

TABLE 3

| Temperature | Acid value |
|---|---|
| (° C.) | mgKOH/g |
| 175 | — |
| 200 | 0.01 |
| 225 | 0.01 |
| 234 | 0.48 |

For the refrigerating machine oil containing Test oil 3 as the base oil, the acid value was maintained at the initial value as long as the heating temperature was below 225° C., and the acid value was suppressed to 0.5 mgKOH/g or less even at the heating temperature of 234° C. Although not shown in Table 3, it was confirmed that, for the refrigerating machine oil containing Test oil 3 as the base oil, the acid value was suppressed to 0.4 mgKOH/g or 0.5 mgKOH/g at the heating temperature of 234° C. even when the addition amount of the acid scavenger was 4% by mass or 6% by mass, respectively.

Table 4 shows the results of the acid values measured in a similar manner with the refrigerating machine oil (initial acid value of 0.01 mgKOH/g) containing Test oil 2 or Test oil 4 as the base oil to which the antioxidant (0.2% by mass or less) and the acid scavenger (0.7% by mass or greater and 1.0% by mass or less) were added.

TABLE 4

Acid value mgKOH/g

| Temperature | Base oil: | Base oil: |
|---|---|---|
| (° C.) | Test oil 2 | Test oil 4 |
| 175 | 0.06 | 0.06 |
| 200 | 0.22 | 0.36 |
| 225 | 1.56 | 1.26 |
| 234 | — | — |

For the refrigerating machine oils containing Test oils 2 and 4 as the base oil, the acid values were suppressed to 0.5 mgKOH/g as long as the heating temperature was below 200° C., but the acid value increased significantly at the heating temperature of 225° C.

### <Test 4: Addition Amount of Acid Scavenger>

For the refrigerating machine oil containing Test oil 3 as the base oil, the acid value was measured in the same manner as in Test 3 by changing the addition amount of the acid scavenger. The initial acid value of the refrigerating machine oil was 0.01 mg KOH/g. As the acid scavenger, decanoic acid glycidyl ester was used. As the antioxidant, 2,6-di-tert, butyl-p-cresol was used.

The test conditions and the test results are shown in Table 5.

### [Table 5]

TABLE 5

| Antioxidant | 0.3 | 0.3 | 0.3 | 0.3 | 0.3 |
|---|---|---|---|---|---|
| (% by mass) | | | | | |
| Acid scavenger | 1.0 | 2.0 | 4.0 | 5.0 | 6.0 |
| (% by mass) | | | | | |
| Test temperature | 220 | | | | |
| (° C.) | | | | | |
| Test time (h) | 168 | | | | |
| Refrigerant | HF0-1336mzz (Z) | | | | |
| Moisture content in | 1000 | | | | |
| oil (ppm) | | | | | |
| Volume of sealed air | 100 | | | | |
| (ppm) | | | | | |
| Acid value | 0.12 | 0.07 | 0.01 | 0.01 | 0.01 |
| (mgKOH/g) | | | | | |

According to Table 5, the acid value after the test was suppressed to 0.2 mgKOH/g or less by adding the acid scavenger at a mass greater than or equal to 1% by mass and less than or equal to 6% by mass with respect to the total mass of the refrigerating machine oil. When the addition amount of the acid scavenger was 2% by mass or greater, the acid value was suppressed to 0.1 mgKOH/g or less, and when the addition amount of the acid scavenger was 3% by mass or greater, no increase in the acid value from the initial number was observed. Although not shown in Table 5, even when the acid scavenger is added at 0.1% by mass or greater and 1% by mass or less, the acid value can be similarly suppressed to 0.5 mg KOH/g or less. Although not shown in Table 5, sludge formation was observed when the acid scavenger was added at 7% by mass or greater.

### <Test 5: Thermal Decomposability>

Thermogravimetry (mass) and differential heat were measured by using a thermogravimetric and differential thermal analyzer (DTG-60, made by SHIMADZU) for the refrigerating machine oil containing Test oil 3 as the base oil (the same composition as that used in Test 3).

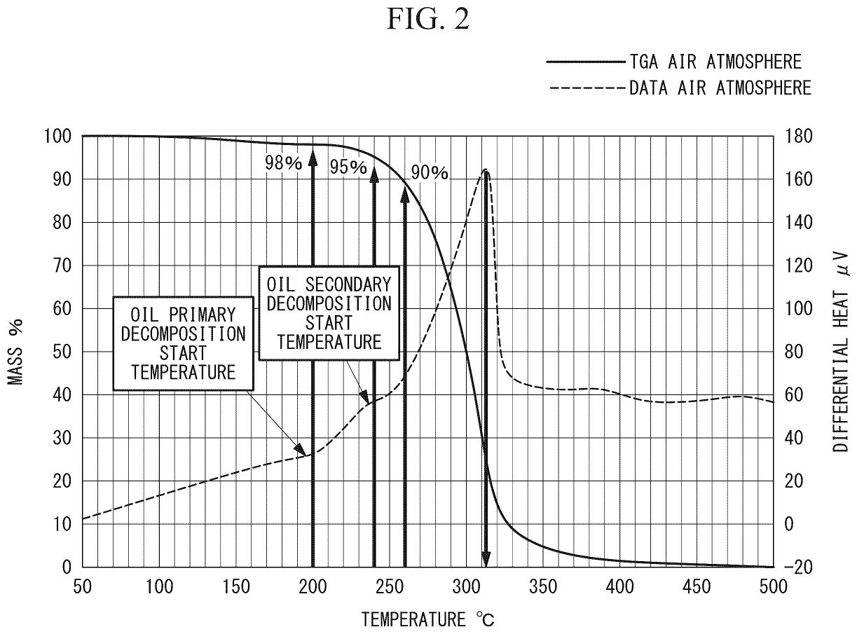

The results are illustrated in FIG. 2. In FIG. 2, the horizontal axis represents temperature (° C.), the left vertical axis represents mass (%), the right vertical axis represents differential heat (uV), the solid line represents transition of mass, and the dashed line represents transition of differential beat. According to FIG. 2, in the refrigerating machine oil containing Test oil 3 as the base oil, the primary decomposition started at 200° C., and the secondary decomposition started at 240° C. It was confirmed that the refrigerating machine oil was decomposed by about 10% when heated to 260° C., but the refrigerating machine oil was decomposed only by about 5% when the temperature was 240° C. or less.

According to Tests 1 to 5 described above, the refrigerating machine oil containing Test oil 3 as the base oil with addition of a predetermined amount of the acid scavenger can be used over a wide range of machine design temperatures greater than or equal to 130° C. and less than or equal to 225° C. Such a refrigerating machine oil has superior thermochemical stability compared to the conventional low-viscosity base oil (for example, ISO VG32, 68, or the like), and can maintain good refrigerant dissolution viscosity and thus ensure lubricity even at high temperatures about 150° C.

The heat source machine according to the present disclosure can be applied to commercial or industrial hot water supply and process drying (steam production). The heat source machine is an alternative machine to boiler products, which generate hot water and steam by burning fossil fuels or the like, and the heat source machine uses electricity to boil water and vaporize the boiled water, thereby reducing emission of the greenhouse gas (CO₂).

### REFERENCE SIGNS LIST

10 heat source machine
11 compressor
11H high-pressure side compressor
11L low-pressure side compressor
12-1 condenser
12-2 condenser
12-3 condenser
13-1 first expansion valve (expansion valve)
13-2 second expansion valve (expansion valve)
14 evaporator
15 refrigerating machine oil supply unit
15a storage unit
15b pump
16 check valve
17 intercooler (interheater)
18-1 intercooler flow regulating valve
18-2 intercooler bypass valve

1. A heat source machine in which a compressor, a condenser, an expansion valve, and an evaporator are connected to each other via a main pipe to form a refrigerant circulation circuit configured to circulate a refrigerant, and the refrigerant circulation circuit is filled with HFO-1336mzz (Z) as a refrigerant, the heat source machine comprising:
a refrigerating machine oil supply unit configured to supply a refrigerating machine oil to the compressor,
wherein the refrigerating machine oil supply unit includes a storage unit storing the refrigerating machine oil,
wherein the refrigerating machine oil includes an ester-based base oil having a dynamic viscosity that is greater than or equal to 100 mm²/s and less than or equal to 180 mm²/s at 40° C. and an epoxy-based acid scavenger at a mass that is greater than or equal to 0.1% by mass and less than or equal to 6% by mass with respect to a total mass of the refrigerating machine oil, and
wherein the machine design temperature is greater than or equal to 130° C. and less than or equal to 225° C.

2. An operation method of a heat source machine in which a compressor, a condenser, an expansion valve, and an evaporator are connected to each other via a main pipe to form a refrigerant circulation circuit configured to circulate a refrigerant, and the refrigerant circulation circuit is filled with HFO-1336mzz (Z) as a refrigerant,
wherein the machine design temperature is greater than or equal to 130° C. and less than or equal to 225° C.,
the operation method comprising:
supplying a refrigerating machine oil to the compressor, the refrigerating machine oil including an ester-based base oil having a dynamic viscosity that is greater than or equal to 100 mm²/s and less than or equal to 180 mm²/s at 40° C. and an epoxy-based acid scavenger at a mass that is greater than or equal to 0.1% by mass and less than or equal to 6% by mass with respect to a total mass of the refrigerating machine oil.

3. A refrigerating machine oil for a heat source machine in which a compressor, a condenser, an expansion valve, and an evaporator are connected to each other via a main pipe to form a refrigerant circulation circuit configured to circulate a refrigerant, and the refrigerant circulation circuit is filled with HFO-1336mzz (Z) as a refrigerant,
wherein the heat source machine comprises a refrigerating machine oil supply unit configured to supply the refrigerating machine oil to the compressor, the refrigerating machine oil supply unit includes a storage unit storing the refrigerating machine oil, and the machine design temperature is greater than or equal to 130° C. and less than or equal to 225° C.,
the refrigerating machine oil for a heat source machine comprising: an ester-based base oil having a dynamic viscosity that is greater than or equal to 100 mm²/s and less than or equal to 180 mm²/s at 40° C. and an epoxy-based acid scavenger at a mass that is greater than or equal to 0.1% by mass and less than or equal to 6% by mass with respect to a total mass of the refrigerating machine oil.
